(19) United States
(12) Patent Application Publication
(10) Pub. No.: US 2007/0112471 A1
(43) Pub. Date: May 17, 2007

(54) Method for determination of load characteristic which indicates the load of electrical primary components

(75) Inventor: Ingo Erkens, Altdorf-Grunsberg (DE)

Correspondence Address: LERNER GREENBERG STEMER LLP, P O BOX 2480, HOLLYWOOD, FL, 33022-2480, US

(73) Assignee: Siemens AG

(21) Appl. No.: 10/566,037

(22) PCT Filed: Jun. 29, 2004
(86) PCT No.: PCT/DE04/01400

§ 371 Date: Jan. 25, 2006

(30) Foreign Application Priority Data
Jul. 25, 2003 (DE) 10334694.5

(51) Int. Cl. H02J 3/00

(52) U.S. Cl. 700/291

(57) ABSTRACT

Details relating to the current operational state of primary components of an electric energy supply system are obtained in a simple manner. The method is used to determine a load characteristic (K1) indicating the load of electric primary components (2) in an electric energy distribution network. The following method steps are performed: descriptive values (M) describing the operational state of the primary component are recorded, especially measuring values of a primary variable, by way of a sensor (3) connected to a field device (5) which carries out functions for the automation of the energy distribution network; the total sum of the descriptive values (M) is determined by the duration of at least one predetermined time interval by forming a load intermediate value (K*) and the load characteristic (K1) is produced according to the variable of the load intermediate value (K1) compared to a predetermined load threshold value.

So-called automation systems are normally used nowadays in order to control and monitor automated processes. The automated processes may, for example, be technical processes, automated production processes and distribution systems for electrical power, for example electrical power supply lines or electrical power supply networks. Automated processes such as these have primary components, that is to say components which are directly associated with the process; in the case of an electrical power distribution system, such primary components may, for example, be power supply lines, circuit breakers, generators, converters and transformers.

An automation system for an automated process normally has field appliances which are connected to the primary components of the respective process, are arranged close to the process and use suitable measurement converters, such as flowmeters and concentration meters as well as current transformers and voltage transformers, to obtain specific measurement data from the process. The process can be monitored and controlled on the basis of this measurement data. The measurement data may, for example, be passed to suitable output appliances, for example screen displays, and may be displayed there, for example in the form of graphics or tables, to the operator of the respective process.

In addition to the actual measurement data, field appliances can also, for example, produce information about the respective operating state of the primary components connected to them. For example, in this context, German Laid-Open Specification DE 100 50 147 A1 discloses a value which indicates the state of machines being obtained by calculation of statistical characteristics from measurement data recorded by the field appliance, and part of which is processed further by computer. Statistical characteristics such as these are, according to the laid open specification, for example mean values, maximum and minimum values, standard deviations and variances. Statistical characteristics calculated for successive time periods are in each case added to one another in order to characterize the machine state; for example, a measure of the aging or wear of the respective primary components is found on the basis of the rate of change of these characteristics.

Furthermore, U.S. Pat. No. 6,490,506 B1 discloses a method in which various measured values, for example the mass flow of a liquid through the turbine, are recorded by means of sensors on a turbine. These measured values are supplied to a monitor in which, for example, the operating efficiency of the turbine or its wear is determined.

The invention is based on the object of obtaining, as simply as possible, details about the instantaneous load state of primary components of an electrical power supply system.

According to the invention, this object is achieved by proposing a method for determination of a load characteristic, which indicates the load level on electrical primary components and in an electrical power distribution network, in which method the following steps are carried out:
description values which describe an operating state of the primary component are recorded by means of a sensor which is connected to a field appliance which carries out functions relating to the automation of the power distribution network,
an overall sum of the description values is determined over the duration of at least one predeterminable time interval in order to form a load intermediate value, and
the load characteristic is produced as a function of the magnitude of the load intermediate value in comparison to a predeterminable load limit value.

The major advantage according to the invention is that information about the instantaneous load state of the respective primary component of a power distribution network can be obtained by means of simple computation operations in the form of addition of the description values over a predetermined time period and of a value comparison, that is to say, for example, a quotient formation from the load intermediate value and the load limit value. Information such as this makes it possible, for example, to distribute the power flow more uniformly in a power supply network, and thus to operate the overall network more effectively and cost-effectively. In this context, in particular measured values of a primary measurement variable, or else, for example, numerical values for counting, for example switching operations of a switch, should be regarded as description values. Description values may be in analog or digital form.

As an advantageous development of the method according to the invention, it is possible to provide for the load characteristic to be emitted from the field appliance or from the field appliance or from a data processing device which is connected to the field appliance. This makes it possible to emit the load characteristic without major additional effort, for example for specific output systems, from the field appliance itself or from a data processing device which is nowadays normally connected to it. The output may, for example, be in visual or audible form.

Furthermore, according to a further advantageous embodiment of the method according to the invention, it is possible to provide for a load signal to be produced and emitted from the field appliance or from a data processing device which is connected to the field appliance as a function of the magnitude of the load characteristic, when the load characteristic indicates a particularly low and/or a particularly high load on the primary component. This makes it possible, for example, for a warning message to be produced in the form of the load signal for the operator of an automation system when the corresponding component is only lightly loaded or is loaded to its load limit. Within the scope of the invention, it is, of course also possible to produce a plurality of load signals, for example in a different form or for different receivers.

According to one advantageous development of the method according to the invention, a sensor which is already provided in an automation system is also used to record the description values. This means that no additional sensor, such as a measurement converter, need be connected to the field appliance for detection of the load characteristic, so that there is no need for any complexity or any costs for additional components. Conventional functions of the field appliance which are already provided may, for example, be protective and monitoring functions, or recording functions.

According to one advantageous refinement of the method according to the invention, measured values of a primary variable are used as description values. In this case, a current flowing through the primary component can advantageously be used as the primary measurement variable. Current measured values represent conventional, frequently used measurement variables in electrical power supply systems.

It is likewise also advantageously feasible to use a voltage that is applied to the primary component as the primary measurement variable. Voltage measured variables likewise represent conventional, frequently used measurement variables in electrical power supply systems. Furthermore, a temperature of the primary component can also advantageously be used as the primary measurement variable. The load of specific primary components, such as electrical supply lines or transformers, can also be indicated comparatively easily with the aid of temperature measured values.

A further advantageous embodiment of the method according to the invention is for the load characteristic to be produced repeatedly, and for successive load intermediate values to be added in a sum memory, forming an aging characteristic. This allows an aging characteristic which indicates aging of the respective primary component to be formed in a particularly simple manner by adding successively determined load characteristics. By way of example, an aging characteristic such as this can be used in order to determine an optimum servicing time for the primary component.

In this case, it is also regarded as advantageous for the aging characteristic to be emitted from the field appliance or from a data processing device which is connected to the field appliance. This makes it possible to emit the aging characteristic in an advantageous form, without any further complexity. This characteristic may be emitted visually or audibly, analogously to the load characteristic.

Furthermore, it is regarded as being advantageous in this case if an aging signal is produced as a function of the magnitude of the aging characteristic in comparison to a predetermined aging limit value for the field appliance or a data processing device which is connected to the field appliance, and the aging signal is emitted from the field appliance or the data processing device. An appropriate signal can be produced in this way, for example, when the corresponding primary component needs to be serviced in the near future. To a very large extent, this avoids unnecessary servicing work or checks of the primary component. A plurality of aging signals can be produced, analogously to the production of a plurality of load signals.

Furthermore, in this context, it is regarded as advantageous for the sum memory to be set to the value zero on starting up the primary component. This is particularly appropriate in the case of primary components which are being used for the first time.

As an alternative to this, in the case of primary components which have already been used in the past or have been stored for a relatively long time period, it may be advantageous for the sum memory to be set to a start value, which takes account of previous use of the primary component, on starting up the primary component.

One advantageous development of the method according to the invention also provides that if the primary component is a circuit breaker, the description values are in each case determined only while the switching contacts of the circuit breaker are open. In the case of a circuit breaker, this allows load characteristics and any aging characteristic which may possibly be produced to be produced exclusively on the basis of the time period during which the switching contacts of a circuit breaker are open, during which time period the circuit breaker is particularly heavily loaded, as a result of arc formation.

Furthermore, it may be advantageous if the primary component is a circuit breaker, the number of switching processes carried out by the circuit breaker is also determined by the field appliance, an aging switching value is determined from this number of switching processes, and the aging switching value or a warning message derived from it is emitted from the field appliance or from a data processing device which is connected to the field appliance. This also allows the aging of a circuit breaker to be indicated on the basis of switching processes which have already been carried out.

### In order to explain the invention further:

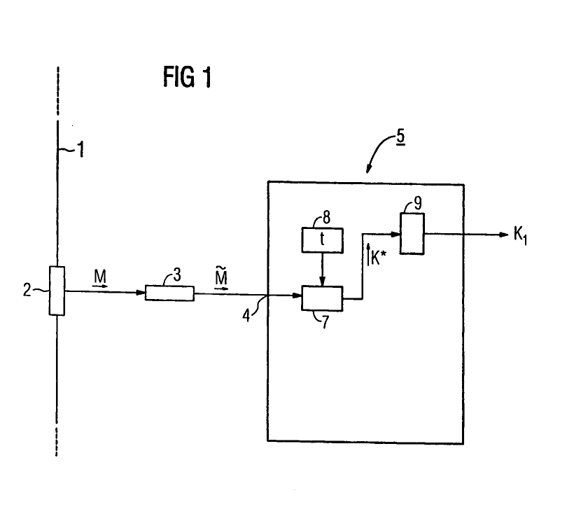

FIG. 1 shows a block diagram of one exemplary embodiment of a field appliance, which is connected to a power transmission network, for production of a load characteristic,

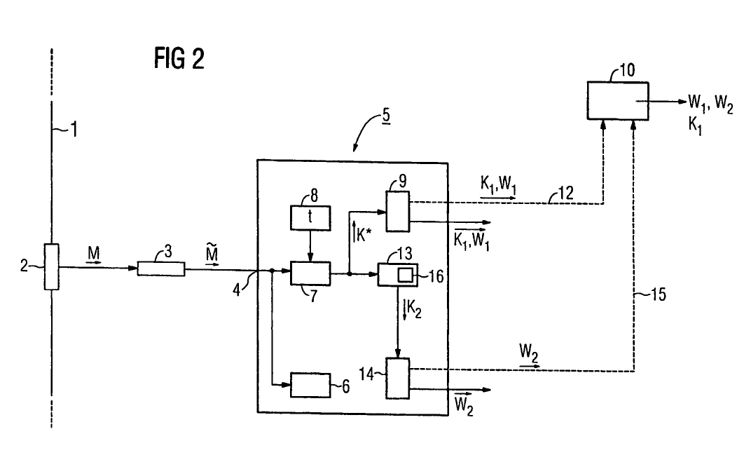

FIG. 2 shows a block diagram of a further exemplary embodiment of a field appliance, which is connected to a power transmission network, for production of a load characteristic and of an aging characteristic,

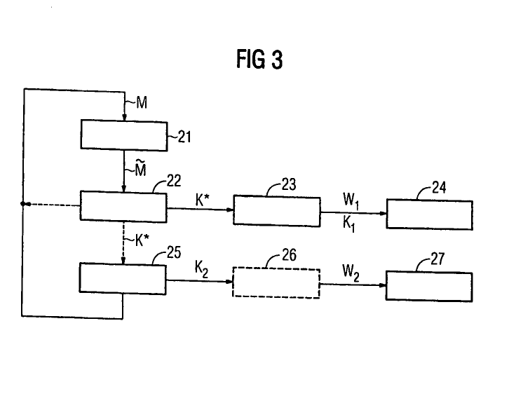

FIG. 3 shows a method scheme for one exemplary embodiment of a method for determination of a load characteristic, and

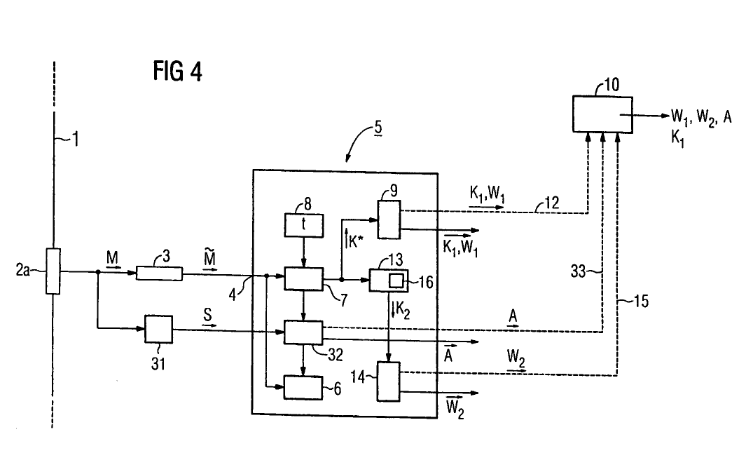

FIG. 4 shows a further exemplary embodiment of a field appliance, which is connected to a power transmission network, in the form of a block diagram.

FIG. 1 shows a schematic block diagram of one exemplary embodiment of a field appliance for production of a load characteristic which indicates the load on a primary component in an electrical power supply network. A line section 1 of a power transmission network, which is not shown in any more detail, or of a power transmission line has a primary component 2, which is indicated only schematically. By way of example, this primary component may be a line part of the line section 1, a transformer, a circuit breaker, a generator or a converter. The components that have been mentioned by way of example are part of the power transmission network itself, as primary components. The primary component 2 is connected to a sensor 3, for example a measurement converter, which is indicated only schematically in FIG. 1 and is itself connected on its output side to an input 4 of a field appliance 5. The field appliance 5 is, for example, part of an automation system for automation of the power supply network. The input 4 of the field appliance 5 is connected to an addition module 7, which is in turn connected by a control input to a timer 8. The addition module 7 is also connected on the output side to a first limit value module 9.

The method of operation of the arrangement illustrated in FIG. 1 will be described in the following text. Primary description values M, for example primary measured values of a primary measurement variable, that is to say of a measurement variable which can be detected directly on the primary component, which are suitable for description of the operating state of the primary component 2, are recorded by means of the sensor 3. In a situation such as this, by way of example, the primary measurement variable may be the temperature of the primary component, a voltage applied to it or a current flowing through the primary component. Primary variables which are based on a current and voltage may, for example, exist in the form of instantaneous values, root mean square values, maximum values or average values. Furthermore, it would also be possible for the primary measurement variables to be in the form of air humidity or, in the case of rotating machines such as generators, a torque that is applied to a shaft, or its speed of revolution. Other primary description values may, for example, be numerical values which indicate the number of switching operations of a switching component, as well as event signals which, for example, indicate that a limit value has been exceeded. Primary description values may be in analog or digital form. The primary description values M are recorded by the sensor 3 and are converted to measured values \tilde{M} which are proportional to the primary description values M. Furthermore, if necessary, the primary description values M may also be digitized in the course of this conversion by the sensor 3, so that the description values \tilde{M} can be transmitted in digital form. The description values \tilde{M} are then supplied to the input 4 of the field appliance 5, and are passed from there to the input of the addition module 7, where the time profile of the description values \tilde{M} is added during a time interval which is predetermined by the timer 8. As the result of the addition process, the addition module 7 produces a load intermediate value K* at its output, and this is supplied to the limit value module 9, which compares the load intermediate value K* with a predeterminable load limit value, and produces a load characteristic K₁ as a function of the result of this comparison. By way of example, a high load characteristic K₁ can be produced in this way when the ratio of the load intermediate value K* to the load limit value is close to unity; conversely, a low load characteristic K₁ can be produced when this ratio is close to 0.

The load characteristic K₁ may be emitted from the field appliance by means of an output device, which is not illustrated in any more detail in FIG. 1. By way of example, the output device may be a device for visual indication of the load characteristic K₁, such as a display or a screen, or may be a device for audible output of the load characteristic, such as a signal horn or a loudspeaker.

A load characteristic K₁ produced in this way makes it simple for the operator of the automation system for the power supply network to optimize the load on specific primary components. For example, the load characteristic K₁ can be used to identify lightly loaded line sections of the power supply network and, as a consequence of this to distribute more electrical power onto such line sections. Analogously, very lightly loaded or very heavily loaded transformers, generators and other primary components of the power supply network can be identified, so that it is possible in this way to distribute the overall load more uniformly throughout the entire power supply network by redistribution of electrical power—to the extent that this is feasible. This allows a power supply network to be operated more effectively overall, and thus also considerably more cost-effectively.

FIG. 2 shows a further exemplary embodiment of a field appliance for production of a load characteristic and of an aging characteristic determined from it. The major aspects of the method of operation for production of the load characteristic are the same as those already explained with reference to FIG. 1. The corresponding components are thus identified by the same reference symbols.

The additional functions of the field appliance 5 in comparison to those in FIG. 1 will be described in the following text. As can be seen from FIG. 2, the limit value module 9 also produces one or more load signals W₁ as a function of the magnitude of the load characteristic K₁ when the load characteristic K₁ is very high or very low. A load signal W₁ such as this may either be emitted directly to the field appliance 5, for example visually or audibly, or may be supplied to an input of a data processing device 10 which, for example, is arranged in a central control station, via a communication line 12 which is suitable for this purpose. The load signal W₁ can be processed further by means of the data processing device 10, or it can be emitted in some suitable form again. Furthermore, it is likewise possible for the load characteristic K₁ to be emitted directly from the field appliance 5 to the data processing device 10 which, after comparison with a load limit value, either indicates the load characteristic K₁ directly or emits a load signal W₁, analogously to the operation of the limit value module 9. The last-mentioned case would thus correspond to the signal production being moved to the data processing device 10.

The load signal W₁ can be produced as a function of the magnitude of the load characteristic K₁, for example, when the primary component is only very lightly loaded. In the same way, the load signal W₁ can be produced when the primary component is very heavily loaded. It is also possible to provide a combination of both conditions for the load signal W₁; it is thus produced in this case when the load on the primary component is light or heavy.

It is also possible for the load signal W₁ to be indicated, for example, in the form of a type of traffic light, in which a red indication indicates that a primary component is loaded close to its load limit, an amber lamp indicates that the primary component is loaded in an intermediate load range, and a green lamp indicates that the primary component is very lightly loaded. Quite clearly, an indication such as this may in each case be modified, for example in terms of colors, in accordance with the respective requirements.

A further function which is added in FIG. 2 in comparison to the field appliance 5 in FIG. 1 comprises the production of a so-called aging characteristic K₂ for the primary component 2. For this purpose, the load intermediate values K* which are generated by the addition module 7 during successive time periods are supplied successively to a sum limit 13, in which they are in turn added. This addition process results in a respective aging characteristic K₂, which is emitted at one output of the sum memory 13. This aging characteristic K₂ thus, so to speak, indicates the accumulated load on the respective primary component up to the current time, and can thus be used to determine the aging of the primary component 2. For example, this can be used to determine an optimum time for servicing, repair or replacement of the primary component 2. The aging characteristic K₂ may either be emitted directly from the field appliance 5 (this is not illustrated in this form in FIG. 2), or may first of all be supplied to a further limit value module 14, which compares the aging characteristic K₂ with a predetermined aging limit value. Depending on the magnitude of the aging characteristic K₂ in comparison to this aging limit value, an aging signal W₂ can in each case be produced which, once again analogously to the load signal W₁, is emitted either directly from the field appliance S or after transmission to the data processing device 10 via a suitable transmission line 15 from the data processing device 10. By way of example, the aging signal W₂ may indicate whether the primary component 2 needs to be serviced or, possibly, whether the overall load-specific life of the primary component 2 will be reached in the near future, and it must thus be replaced. A visual indication of the aging signal W₂ may once again be provided, for example, in the form of a traffic light indication (for example green: little aging, amber: medium aging, red: close to the age limit or “servicing required”).

The further limit value module 14 may also be moved from the field appliance 5 to the data processing device 10.

The sum memory 13 has an initial value range 16, in which a start value can be entered for the addition of the load intermediate values K* in order to form the aging characteristic K₂. In the case of a new (unused) primary component, zero is normally entered in this case as the start value, since the entire load-specific life of the component is still in the future. If the primary component has already been used once, or other aging of the primary component has taken place, for example as a result of unfavorable environmental influences, such as high air humidity or temperature during storage of the primary component, the start value can also be set to a value other than zero, in order to indicate that a certain amount of aging of the primary component has already taken place. This at the same time shortens the load-specific life of the primary component that still remains before its maximum aging limit is reached.

FIG. 2 also illustrates a functional block 6 by means of which the field appliance 5 can carry out further automation functions for the power supply network or the primary component 2. For example, functions such as these may be protective functions for monitoring of compliance with specific operating parameters by the primary component 2; however, these functions may also include a recording function for recording and storage of time profiles of the description values \tilde{M}. As can be seen from FIG. 2, the same description values \tilde{M} as those which are also used to determine the load characteristic K₁ are applied to the input side of the functional block 6. This particularly advantageously allows a plurality of functions of the field appliance to be carried out on the basis, for example, of measured values of only a single measurement variable, for example of a root mean square current value, so that, when by way of example a field appliance which can already carry out the functions contained in the functional block 6 is upgraded by the addition of a further function for the production of the load characteristic K₁ and of the aging characteristic K₂ as well, no further components such as additional sensors or measurement converters are required. The load characteristic K₁ and the aging characteristic K₂ can thus be produced in this way without any additional costs.

The components of the field appliance shown in FIGS. 1 and 2, for example the addition module 7, the timer 8 and the limit value modules 9 and 14, should in this context be regarded only as functional modules and therefore need not be in the form of components of the field appliance 5 in their own right. In fact, nowadays, it is normal for functional modules such as these to be in the form of control software for the field Appliance 5. Individual modules of the control software would then carry out the functions of the function modules that have been mentioned.

Once again, a method for production of a load characteristic K₁ and of an aging characteristic K₂ are illustrated by way of example in FIG. 3, in the form of a schematic flowchart.

Primary description values M are detected in a detection step 21 and, after conversion and possibly digitization, are transferred as description values \tilde{M} to an addition step 22. A load intermediate value K* is produced in this addition step 22 by addition of the description values \tilde{M} over a predetermined time period. This intermediate value K* is supplied to a comparison step 23, where it is compared with a load limit value, and a load characteristic K₁ is produced on the basis of the magnitude of the load intermediate value K* in comparison to the load limit value. Furthermore, a load signal W₁ can optionally be produced when the load characteristics K₁ are very high or very low. The load characteristic K₁ and, if appropriate the load signal W₁, is or are emitted in a suitable form in an output step 24 which ends this branch of the method illustrated in FIG. 3.

In parallel with the emission of the load characteristic K₁ and of the load signal W₁ in the output step 24, the use of the method can also be ended at step 22, and the primary description value recording can start again with the detection step 21. This results in a sequence of successive load characteristics K₁ and load signals W₁ being produced.

Optionally, however, step 2 can also be followed by a further addition step 25 in which the respective load intermediate values K* are now added up, thus forming an accumulated sum of the load intermediate values K*. This results in a so-called aging characteristic K₂ being produced, which indicates the wear or the aging of the corresponding primary component. The aging characteristic K₂ can optionally be supplied to a further comparison step 26, in which the respective aging characteristic K₂ is compared with an aging limit value, and an aging signal W₂ is produced on the basis of the magnitude of the aging characteristic K₂ in comparison to the aging limit value, and is finally supplied to a further output step 27.

The limit value comparison in the step 26 may in fact also be omitted, with the aging characteristic K₂ in this case being emitted directly in the output step 27.

After the step 25, the method is started again with the detection step 21, and a new run starts.

Finally, FIG. 4 shows a further exemplary embodiment of a field appliance for production of a load characteristic. FIG. 4 essentially matches FIG. 2. Identical components are also once again provided with the same reference symbols in this case. The following analysis is based on the assumption that the primary component 2 (see, for example, FIG. 1) is an electrical circuit breaker 2a.

A switching operation detection device 31 is additionally connected to the electrical circuit breaker 2a in FIG. 4. The switching operation detection device 31 can, as is shown in FIG. 4, have the same primary description values M of the primary component, that is to say of the circuit breaker 2a, applied to it as the integration module 7; however, it is also feasible for other primary description values to be applied to the switching operation detection device 31. Furthermore, the switching operation detection device 31 may also contain a converter device, in order to produce proportional description values, which correspond to the primary description values. The switching operation detection device 31 is used to identify switching processes of the circuit breaker 2a, for example on the basis of characteristic current profiles. Whenever a switching operation such as this is detected, a switching signal S is emitted to the field appliance 5.

In contrast to the arrangement illustrated in FIG. 4, the switching operation detection device 31 may, however, also be included within the field appliance 5.

The switching signal S is transmitted to an assessment module 32, which counts the switching operations carried out by the circuit breaker 2a and compares this total with the maximum number of switching processes intended for the circuit breaker 2a. The assessment module 32 then emits an aging switching value A, which can in turn be emitted directly at the field appliance 5, or can be emitted after transmission via a communication line 33 to the data processing device 10. The aging switching value A can in this case directly indicate the number of switching processes already carried out or else, for example, the number of switching processes which can still be carried out. Furthermore, an indication can also be displayed analogously to the load characteristic K₁ and to the aging characteristic K₂ in the form of a colored traffic light indication, in which case, for example, green indicates that a small number of switching processes have already been carried out, amber that a medium number of switching processes have already been carried out, and red that the number of switching processes carried out is close to the maximum possible number of switching processes which may be carried out.

When the primary component is a circuit breaker 2a, in order to determine the load characteristic K₁ on the basis, for example, of the route mean square value of a current flowing through the switching contacts of the circuit breaker, the current which shall be considered is, in particular, that current which flows in the form of an arc between the switching contacts during the process of opening the circuit breaker, since the switching contacts are subject to severe loads and wear during this time, and this contributes to the aging of the circuit breaker. By way of example, in a situation such as this, the field appliance identifies an opening process of the circuit breaker and records description values \tilde{M} for determination of the load characteristic K₁ only at this time. The aging characteristic K₂ for a circuit breaker is likewise then determined only on the basis of load intermediate values K* determined during opening of the switching contacts.

1-15. (canceled)

16. A method of determining a load characteristic (K₁) indicating a load level on an electrical primary component (2) of an electrical power distribution network, the method which comprises:
recording description values (\tilde{M}) describing an operating state of the primary component by way of a sensor (3) connected to a field appliance (5) carrying out functions related to an automation of the power distribution network;
determining an overall sum of the description values (\tilde{M}) over a duration of at least one predeterminable time interval to form a load intermediate value (K*); and
producing the load characteristic (K₁) in dependence on a magnitude of the load intermediate value (K*) in comparison with a predeterminable load limit value.

17. The method according to claim 16, which comprises outputting the load characteristic (K₁) from the field appliance (5) or from a data processing device (10) connected to the field appliance (5).

18. The method according to claim 16, which comprises producing a load signal (W₁) and emitting the load signal (W₁) from the field appliance (5) or from a data processing device (10) connected to the field appliance (5), as a function of the magnitude of the load characteristic (K₁), when the load characteristic (K₁) indicates that the load on the primary component (2) is particularly low and/or particularly high.

19. The method according to claim 16, which comprises utilizing a sensor that is already present in the automation system to record the description values ({tilde over (M+EE). )}

20. The method according to claim 16, which comprises using as description values (\tilde{M}) measured values of a primary measurement variable.

21. The method according to claim 20, wherein the primary measurement variable is a current through the primary component (2).

22. The method according to claim 20, wherein the primary measurement variable is a voltage applied to the primary component (2).

23. The method according to claim 20, wherein the primary measurement variable is a temperature of the primary component (2).

24. The method according to claim 16, which comprises:
repeatedly producing the load characteristic (K₁); and
adding successive load intermediate values (K*) in a sum memory (13) to form an aging characteristic (K₂).

25. The method according to claim 24, which comprises outputting the aging characteristic (K₂) from the field appliance (5) or from a data processing device (10) connected to the field appliance (5).

26. The method according to claim 24, which comprises:
generating, with the field appliance (5) or a data processing device (10) connected to the field appliance (5), an aging signal (W₂) as a function of a magnitude of the aging characteristic (K₂) in comparison with a predetermined aging limit value; and
outputting the aging signal (W₂) from the field appliance (5) or the data processing device (10).

27. The method according to claim 24, which comprises setting a sum memory (13) to zero value on starting up the primary component (2).

28. The method according to claim 24, which comprises setting a sum memory (13) to a start value on starting up the primary component (2), the start value taking account of a previous use of the primary component (2).

29. The method according to claim 24, wherein the primary component is a circuit breaker (2a) with switching contacts, and the method comprises determining the description values (\tilde{M}) in each case only while the switching contacts of the circuit breaker (2a) are open.

30. The method according to claim 16, wherein the primary component is a circuit breaker (2a) and the method further comprises:
determining a number of switching processes carried out by the circuit breaker (2a) with the field appliance (5);
determining an aging switching value (A) from the number of switching processes; and
outputting the aging switching value (A) or a warning message derived therefrom with the field appliance (5) or with a data processing device (10) connected to the field appliance (5).
